(19) United States
(12) Patent Application Publication
(10) Pub. No.: US 2004/0006641 A1
(43) Pub. Date: Jan. 8, 2004

(54) Use of multi-format encapsulated internet protocol messages in a wireless telephony network

(76) Inventors: Nischal Abrol, San Diego, CA (US); Marcello Lioy, San Diego, CA (US); Sivaramakrishna Veerepalli, Poway, CA (US)

Correspondence Address: Qualcomm Incorporated, Patents Department, 5775 Morehouse Drive, San Diego, CA, 92121-1714, US

(21) Appl. No.: 10/188,636

(22) Filed: Jul. 2, 2002

(51) Int. Cl. G06F 15/16

(52) U.S. Cl. 709/245

(57) ABSTRACT

In order to assist an exchange of data between one or mobile communications devices and the Internet in a mobile communications network, bidirectional tunneling of IPv6 messages inside IPv4 messages is performed between a home agent and one or more foreign agents. Optionally, where a mobile communications device is a wireless mobile unit, the mobile unit itself automatically engages in bidirectional tunneling of IPv6 messages inside IPv4 messages with the home agent whenever the wireless mobile unit detects loss of wireless coverage in the mobile communications network and presence of coverage in a type of wireless network lacking foreign agent functionality.

### BACKGROUND

1. Field

The present invention generally relates to the transmission, relay, and receipt of messages in a wireless telephony network, and more particularly, to techniques for using internet protocol (IP) messages of a new format incompatible within legacy telephony equipment by encapsulating the IP messages within messages of recognized format.

2. Background

According to widely known standards, each entity that is coupled to the Internet is recognized by a unique code called an “IP address.” As one example, a computer receives an IP address when it activates a dialup modem to connect to the Internet. The same is true of Internet routers, servers, and other traditional components of the Internet. Some entities have a full-time, permanent IP address known as a “static” IP address, whereas other entities receive a new “dynamic” IP address each time they connect to the Internet.

Until recently, the dominant standard governing IP addresses has been “IPv4,” promulgated by the Internet Engineering Task Force (IETF). IPv4 specifies a format for IP addresses including, among many other details, a length of 32 bits. The explosive use of the Internet is probably greater than the expectations of many including standards groups such as the IETF. Contributing to this are greater numbers of people going online, as well as the unforeseen mobility of the Internet through wireless phones, airport kiosks, coffee shops, and countless other connection points. With all conceivable 32 bit numbers, there soon will be a shortage to accommodate all of these people and devices.

In response, the IETF has developed a new format of IP address called “IPv6.” Among other improvements, IPv6 provides for 128 bit IP addresses instead of 32 bits. Although IPv6 is likely to provide a number of improvements, including relief for the constraints of 32 bit IP addresses, there are new issues. For instance, most equipment is not compatible with the new IPv6 standard since Ipv6 was not even conceived when this equipment was manufactured. One solution is to simply replace the legacy components with new, IPv6 compatible machines. In some cases, hardware may be retained if the software and/or firmware is changed. Whether the upgrade is implemented in hardware, software, or both, money is required to purchase the equipment or software and to hire technicians to install it. There are also costs associated with system down-time while the upgrades are being done.

Although the advent of IPv6 provides some improvements, then, certain problems are also caused by the need to upgrade equipment to achieve IPv6 compatibility.

### SUMMARY

In order to assist an exchange of data between one or mobile communications devices and the Internet in a mobile communications network, bidirectional tunneling of IPv6 messages inside IPv4 messages is performed between a home agent and one or more foreign agents. Optionally, where a mobile communications device is a wireless mobile unit, the mobile unit itself automatically engages in bidirectional tunneling of IPv6 messages inside IPv4 messages with the home agent whenever the wireless mobile unit detects loss of wireless coverage in the mobile communications network and presence of coverage in a type of wireless network lacking foreign agent functionality.

### BRIEF DESCRIPTION OF THE DRAWINGS

FIGS. 1A-1B show the hardware components and interconnections of two different examples of wireless telephony network.

FIG. 2 is an exemplary digital data processing machine.

FIG. 3 is an exemplary signal bearing medium.

FIG. 4 is a flowchart of a first registration sequence.

FIG. 5 is a flowchart of a second registration sequence.

FIG. 6 is a flowchart of a third registration sequence.

FIG. 7 is a flowchart of a first transmit/receive sequence.

FIG. 8 is a flowchart of a second transmit/receive sequence.

FIG. 9 is a flowchart of a multi-mode sequence.

### DETAILED DESCRIPTION

The nature, objectives, and advantages of the invention will become more apparent to those skilled in the art after considering the following detailed description in connection with the accompanying drawings.

Hardware Components & Interconnections

Introduction

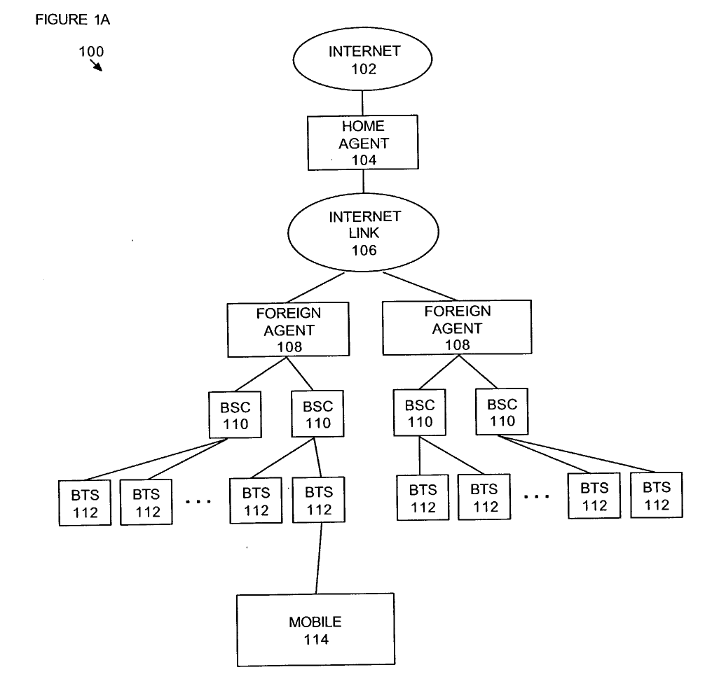

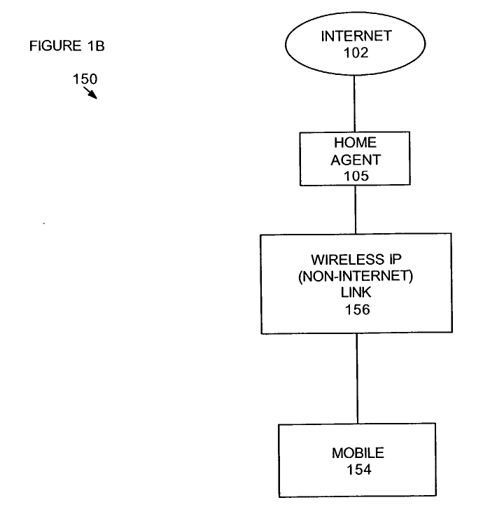

One aspect of the present disclosure is a wireless communications system, which may be implemented in a variety of different ways. FIG. 1A shows one example 100, and FIG. 1B shows another example 150. In either case, a communications exchange network comprises a mobile IPv4 network, configured to relay IPv4 type messages between a mobile communications device (“mobile”) and the Internet 102. In the case of FIG. 1A, the network 100 as illustrated comprises an IP-capable wireless telephone network such as a CDMA network, and the mobile 114 comprises an IP-capable wireless telephone. In the case of FIG. 1B, the network 150 as illustrated comprises a non-IP wireless network such as an 802.11 type network, and the mobile 154 comprises an IP capable wireless telephone.

Network 100 (FIG. 1A)

Referring to FIG. 1A in greater detail, the network 100 includes a number of components interconnecting the Internet 102 to numerous mobile communications devices (such as the illustrated mobile 114). These components include various base stations 112 (BTSs), base station controllers 110 (BSCs), and foreign agents 108. An Internet link 106 is provided between the foreign agents 108 and a home agent 104.

Broadly, the home agent 104 serves to receive IP packets arriving from the mobile 114 via one of the foreign agents 108, and direct the packets to the Internet 102. In the opposite direction, the home agent 104 receives IP packets from the Internet 102, and when these packets are directed to the IP address of the mobile 114, the home agent 104 routes the packets to the mobile 114 via the appropriate foreign agent 108.

As one example, the foreign agent 108 may be implemented by a packet data switching node (PDSN) that incorporates foreign agent functionality, with one example being described by the well known IS-835 standard. The foreign agents 108 perform an IP routing function, receiving IP messages arriving from the home agent 104 via the Internet link 106 and redirecting the messages to the mobile 114. The foreign agent 108 also perform the opposite function, forwarding IP messages from mobile communication devices 114 to the home agent 104 for relay to the Internet 102.

The BTS 112 and BSC 110 components comprise suitable electronic equipment to relay messages between mobiles 114 and foreign agents 108. Many suitable examples are known in the art, some or all of which are commercially available.

One example of the system 100 is a mobile IPv4 network such as a CDMA 2000 network. In this particular example, the components of the network 100 may be implemented as known in the art, with specific guidance being available from the Internet Engineering Task Force (IETF) Request for Comments (rfc) document entitled “rfc 2000,” and also from the well known IS-835 standard.

Nevertheless, to make an IPv4 network work with IPv6 packets according to the present disclosure, a number of changes are required. For example, the home agent 104 is reprogrammed so that it is capable of performing IPv6 inside IPv4 tunneling. From the perspective of the home agent 104, this involves receiving IPv4 packets containing IPv6 messages from the foreign agents 108, unencapsulating the inner IPv6 messages and transmitting them to the Internet 102. The home agent 104 also performs the opposite task, namely, receiving IPv6 packets from the Internet 102, encapsulating them within IPv4 messages, and forwarding them on to the appropriate foreign agent 108. These modifications to the home agent 104 may be implemented, for example, by ensuring that the home agent has properties such as the following: a dual IPv4/v6 stack; the ability to understand any special RRQ extensions and generate appropriate RRP extensions to support IPv6 addressing through Mobile IPv4; the ability to unencapsulate IPv6 packets that will be carried inside the IPv4 tunnel.

As for the foreign agents 108, each is modified to include capability to perform IPv6-inside-IPv4 tunneling, namely, encapsulating IPv6 messages from the mobiles 114 inside IPv4 messages and transmitting them over the Internet link 106, and likewise, unencapsulating IPv6-inside-IPv4 messages from the home agent 104 and forwarding the IPv6 message to the appropriate mobile 114. Foreign agents 108 may be reprogrammed in this way by making a number of changes, such as the following. Ingress filtering requirements are relaxed when IPv6 packets are sent directly to the foreign agent and tunneled from foreign agent to home agent; instead, ingress filtering is left to the upstream home agent. Upon seeing the IPv6 protocol number in PPP, the foreign agent is reprogrammed not to drop the packet, but instead to forward it. In addition, the foreign agent is programmed to ignore the MN-HA extension to get the IPv6 address if used, to tunnel the IPv6 packets that it received over the link layer, and to accept the reverse tunneling requested by the mobile station.

As for the mobile 114, in order to work with the illustrated system 100 the mobile 114 must be capable of sending and receiving mobile IPv6 messages. The mobile 114 is also programmed to request reverse tunneling by the foreign agent 108 and/or home agent 104. The mobile 114 is also programmed to perform IPv6 neighbor discover to get an IPv6 address from the home agent.

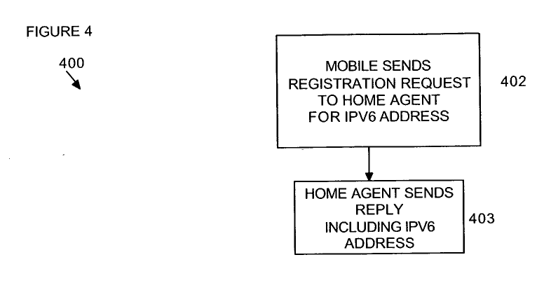

Further details of the operation of components such as the home agent 104, foreign agents 108, and mobiles 114 is discussed in greater detail below in conjunction with FIGS. 4-9.

Network 150 (FIG. 1B)

Referring to FIG. 1B in greater detail, the network 150 includes various components coupling the Internet 102 to a number of mobile communications devices such as the illustrated device 154. These various components, as illustrated, include a wireless IP (non-Internet) link 156 and home agent 105.

The non-Internet link 156 comprises an appropriate system, network, machine, or other IP-compatible equipment to perform communications such as Ethernet, Bluetooth, WCDMA, 802.11, etc.

As with the home agent 104 of FIG. 1A, the home agent 105 serves to direct IP packets arriving from the mobile communications device 154 to the Internet 102. Rather than arriving from a foreign agent, however, IP packets arrive at the home agent 105 from the wireless non-Internet link 156. The home agent also conducts similar communications in the reverse direction.

As in FIG. 4A, the home agent 105 may be implemented by equipment according to IETF rfc 2000 and IS-835, further programmed to include the capability to perform IPv6 inside IPv4 tunneling. From the perspective of the home agent 105, this involves receiving IPv4 packets containing IPv6 messages from the device 154, unencapsulating the inner IPv6 messages and transmitting them to the Internet 102. The home agent 105 also performs the opposite task, namely, receiving IPv6 packets from the Internet 102, encapsulating them within IPv4 messages, and forwarding them on to the mobile communications device 154 via the link 156.

As for the mobile communications device 154, in order to work with the illustrated system 150, the device 154 must be capable of encapsulating IPv6 messages within IPv4 messages, that is, IPv6 inside IPv4 tunneling. The device 154 must also be capable of unencapsulating messages in the opposite direction.

Exemplary Digital Data Processing Apparatus

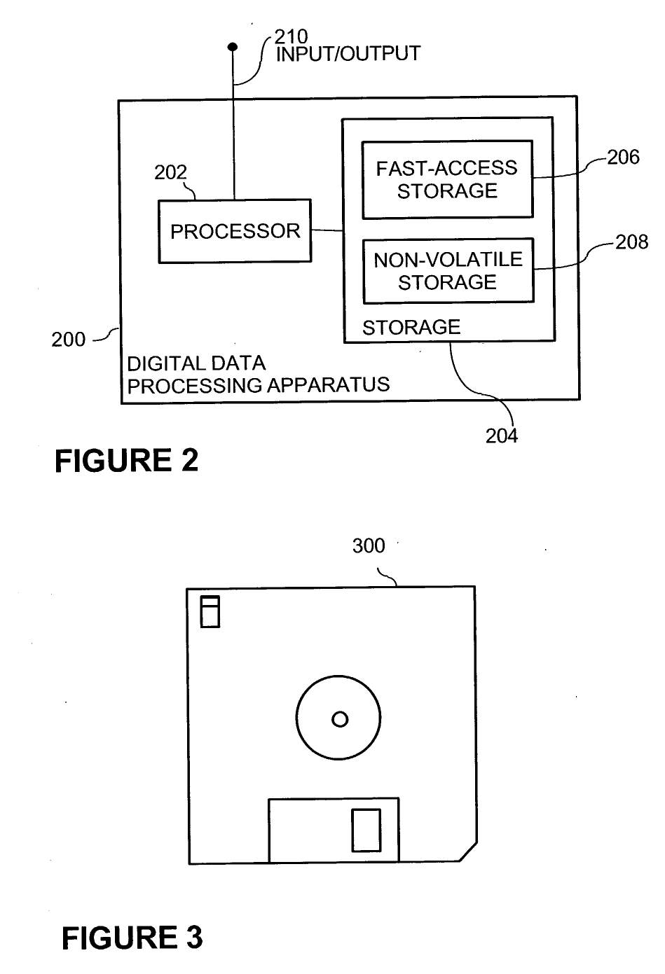

As mentioned above, data processing entities of the systems discussed herein may be implemented in various forms. One example is a general purpose digital data processing apparatus, exemplified by the hardware components and interconnections of the digital data processing apparatus 200 of FIG. 2.

The apparatus 200 includes a processor 202, such as a microprocessor, personal computer, workstation, controller, microcontroller, state machine, or other processing machine, coupled to a storage 204. In the present example, the storage 204 includes a fast-access storage 206, as well as nonvolatile storage 208. The fast-access storage 206 may comprise random access memory (“RAM”), and may be used to store the programming instructions executed by the processor 202. The nonvolatile storage 208 may comprise, for example, battery backup RAM, EEPROM, flash PROM, one or more magnetic data storage disks such as a “hard drive”, a tape drive, or any other suitable storage device. The apparatus 200 also includes an input/output 210, such as a line, bus, cable, electromagnetic link, or other means for the processor 202 to exchange data with other hardware external to the apparatus 200.

In one particular implementation, the apparatus 200 may constitute a wireless communications device such as a CDMA phone, with additional components as applicable, such as one or more microphones, speakers, displays, amplifiers, drivers, CDMA processing circuitry, duplexers, antennae, and the like. The structure, interconnection, and operation of such components are generally known in the art to which ordinarily skilled artisans are familiar.

Despite the specific foregoing description, ordinarily skilled artisans (having the benefit of this disclosure) will further recognize that the apparatus discussed above may be implemented in a machine of different construction, without departing from the scope of the invention. As a specific example, one of the components 206, 208 may be eliminated; furthermore, the storage 204, 206, and/or 208 may be provided on-board the processor 202, or even provided externally to the apparatus 200.

Logic Circuitry

In contrast to the digital data processing apparatus discussed above, a different embodiment of the invention uses logic circuitry instead of computer-executed instructions to implement various processing entities such as those mentioned above. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

### Operation

Having described the structural features of the present invention, the operational aspect of the present invention is now described. As mentioned above, one operational aspect of the present disclosure involves the transmission, relay, and receipt of messages in a wireless telephony network, and more particularly, to techniques for using IP messages of a new format incompatible within legacy telephony equipment by encapsulating the IP messages within messages of recognized format.

Signal-Bearing Media

Wherever any functionality of the invention is implemented using one or more machine-executed program sequences, such sequences may be embodied in various forms of signal-bearing media. In the context of FIG. 2, such a signal-bearing media may comprise, for example, the storage 204 or another signal-bearing media, such as a magnetic data storage diskette 300 (FIG. 3), directly or indirectly accessible by a processor 202. Whether contained in the storage 206, diskette 300, or elsewhere, the instructions may be stored on a variety of machine-readable data storage media. Some examples include direct access storage (e.g., a conventional “hard drive”, redundant array of inexpensive disks (“RAID”), or another direct access storage device (“DASD”)), serial-access storage such as magnetic or optical tape, electronic non-volatile memory (e.g., ROM, EPROM, flash PROM, or EEPROM), battery backup RAM, optical storage (e.g., CD-ROM, WORM, DVD, digital optical tape), paper “punch” cards, or other suitable signal-bearing media including analog or digital transmission media and analog and communication links and wireless communications. In an illustrative embodiment of the invention, the machine-readable instructions may comprise software object code, compiled from a language such as assembly language, C, etc.

Logic Circuitry

In contrast to the signal-bearing medium discussed above, some or all of the invention's functionality may be implemented using logic circuitry, instead of using a processor to execute instructions. Such logic circuitry is therefore configured to perform operations to carry out the method aspect of the invention. The logic circuitry may be implemented using many different types of circuitry, as discussed above.

Registration Sequence—First Example

FIG. 4 shows a sequence 400 to illustrate an exemplary technique for making the mobile communications device known to a home agent. The sequence 400 is described in the context of FIG. 1A, although the same principles apply to the environment of FIG. 1B.

In step 402, the mobile 114 transmits a registration request to the home agent 104. The registration request advises the home agent 104 of the device 114's presence in the network 100. The registration request may resemble an IPv4 registration request conducted according to the well known IS-835 standard, except for an added component of the request that asks for an IPv6 address for the mobile 114 in addition to the IPv4 address. This added feature may be implemented, for example, in the form of a new extension to a known Mobile IPv4 request.

In step 403, the home agent sends a reply to the mobile 114, including an IPv4 address and an IPv6 address as requested. The reply may also be conducted in accordance with IS-835, except for the feature that the reply includes an IPv6 address in addition to the IPv4 address.

Registration Sequence—Second Example

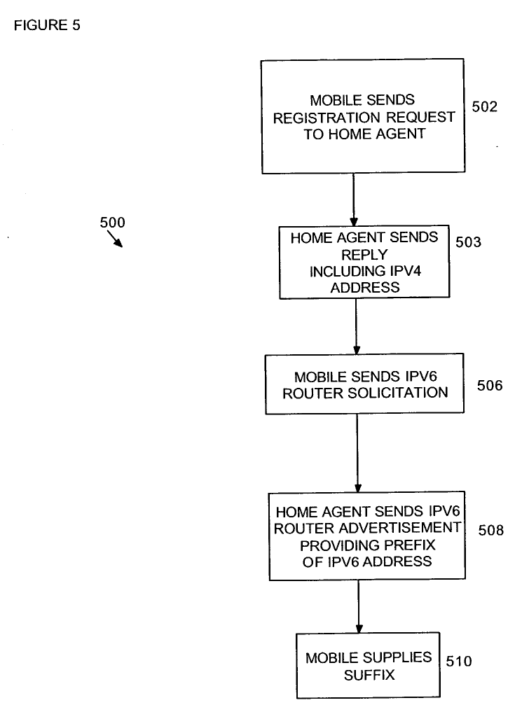

FIG. 5 shows a sequence 500 to illustrate an exemplary technique for making the mobile communications device known to a home agent. The sequence 500 is described in the context of FIG. 1A, although the same principles apply to the environment of FIG. 1B.

In step 502, the mobile 114 sends a registration request to the home agent 104. The request may be conducted according to the IS-835 standard for Mobile IPv4 requests. In step 503, the home agent 104 replies with information including an IPv4 address. The reply of step 503 may also be conducted according to IS-835.

In step 506, the mobile 114 sends an IPv6 router solicitation to the home agent 104. Unlike the registration (step 502), the solicitation seeks an IPv6 prefix so that the mobile can acquire a IPv6 address.

In step 508, the home agent 104 responds with an IPv6 router advertisement, which provides some or all of an IPv6 address for use by the mobile 114. For example, the advertisement may include a prefix portion of an IPv6 address, for completion of the mobile 114 itself. In this respect, step 510 shows the mobile 114 supplying a suffix, such as an Interface ID, to complete the IPv6 address. As one example, the steps 506, 508, 510 may be conducted, for example, according to a known standard for IPv6 solicitation/advertisement, such as rfc 2461.

Registration Sequence—Third Example

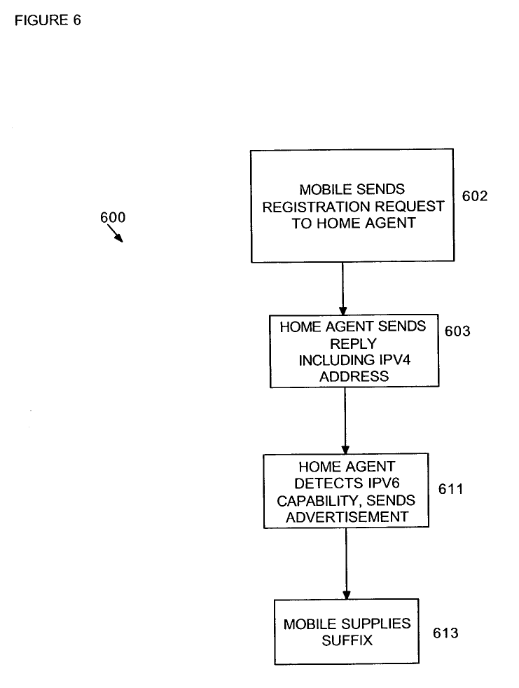

FIG. 6 shows a sequence 600 to illustrate an exemplary technique for making the mobile communications device known to a home agent. The sequence 600 is described in the context of FIG. 1A, although the same principles apply to the environment of FIG. 1B.

In step 602, the mobile 114 sends an IPv4 registration request to the home agent 104. The request may be conducted according to the IS-835 standard for Mobile IPv4 requests. In step 503, the home agent 104 replies with information including an IPv4 address. The reply of step 503 may also be conducted according to IS-835.

In step 611, the home agent 104 detects that the mobile 114 has IPv6 capability. This may be achieved, for example, by cross-referencing an identifier for the mobile 114 (such as a NAI or other appropriate code) against a list of mobiles accessible through the AAA protocols. If the mobile 114 has IPv6 capability according to the database, the home agent 104 sends an IPv6 router advertisement to the mobile 114. The advertisement, provides some or all of an IPv6 address for use by the mobile 114. For example, the advertisement may include a prefix portion of an IPv6 address, for completion of the mobile 114 itself, in which case the mobile 114 provides an appropriate suffix. In this respect, step 613 shows the mobile 114 supplying a suffix, such as an Interface ID, to complete the IPv6 address. As one example, the steps 506, 508, 510 may be conducted, for example, according to a known standard for IPv6 solicitation/advertisement, such as rfc 2462 and rfc 2461.

Transmission Sequence—CDMA Network

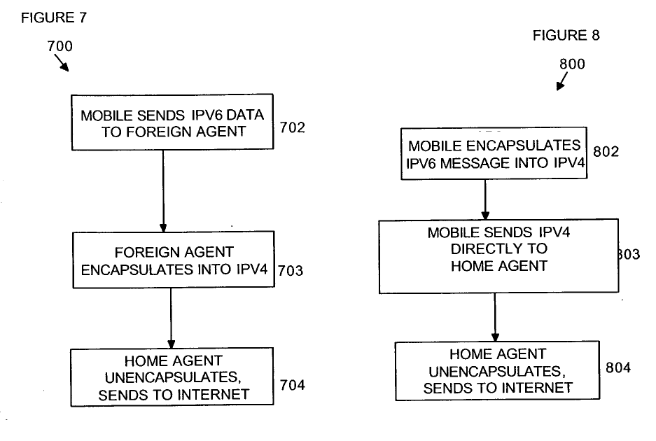

FIG. 7 shows a sequence 700 showing transmission of data from a mobile 114 to the Internet 102 in the environment 100 of FIG. 1A. The sequence 700 is conducted after the mobile 114 is registered with the home agent 104, which may be achieved by one of the sequences such as 400, 500, 600 discussed above.

In step 702, the mobile 114 sends IPv6 data to a selected one of the foreign agents 108. The foreign agent 108 may be determined by known algorithms which consider factors such as loading on the PDSN, hashing based on mobile IMSI, which BTS is communicating with the mobile 114, etc. In step 703, the foreign agent 108 performs reverse tunneling in order to encapsulate the mobile's IPv6 data into IPv4 format. For instance, the foreign agent 108 may add an IPv4 header to the IPv6 data to structure it as an IPv4 message. The foreign agent 108 then routes the encapsulated message to the home agent 104 via the Internet link 106. Encapsulation of this message guarantees that it is passed-on by the Internet link 106, even if the link 106 includes components incompatible with IPv6. In step 704, the home agent 104 receives the encapsulated message, unencapsulates it to reveal the underlying IPv6 message, and transmits the IPv6 message to the Internet 102.

Messages from the Internet 102 to the mobile 114 occur in the opposite sequence.

Transmission Sequence—Non-CDMA Network

FIG. 8 shows a sequence 800 showing transmission of data from a mobile 154 to the Internet 102 in the environment 150 of FIG. 1B. In this sequence, the mobile 154 performs tunneling since there is no foreign agent. Accordingly, the mobile 154 acts as a co-located foreign agent. The sequence 800 is conducted after the mobile 154 is registered with the home agent 105, which may be achieved by one of the sequences such as 400, 500, 600 discussed above.

In step 802, the mobile 154 performs reverse tunneling in order to encapsulate the mobile's IPv6 data into IPv4 format. For instance, the mobile 154 may add an IPv4 header to the IPv6 data to structure it as an IPv4 message. Then, in step 803, the mobile 154 routes the encapsulated message to the home agent 105 via the link 156. The message is sent directly to the home agent 105 since there is no foreign agent.

In step 804, the home agent 154 receives the encapsulated message, unencapsulates it to reveal the underlying IPv6 message, and transmits the IPv6 message to the Internet 102.

Messages from the Internet 102 to the mobile 154 occur in the opposite sequence.

Transmission Sequence—Dual Mode

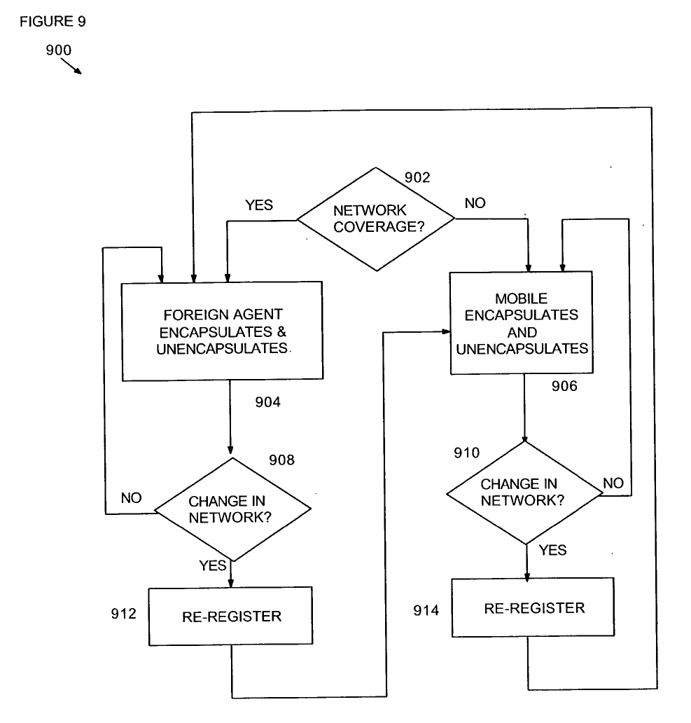

FIG. 9 shows a multi-mode sequence 900 showing transmission of data from a mobile to the Internet 102, which is applicable to both of the environments 100, 150 (FIGS. 1A-1B). In this sequence, tunneling is performed by the foreign agent some times, and by the mobile at other times. The sequence 900 is conducted after the mobile is registered with the home agent, which may be achieved by one of the sequences such as 400, 500, 600 discussed above.

In step 902, the mobile determines whether it is receiving service, or sufficiently strong or error free service, from the network 100. If so, the mobile is apparently present in the network 100 (FIG. 1A), and step 904 is performed. In step 904, the foreign agent 108 performs the IPv6 within IPv4 tunneling. This is achieved by the sequence 700 (FIG. 7). Compared with step 906 (described below), step 904 offers less air bandwidth consumption since the messages between mobile and foreign agent are shorter.

On the other hand, if service from the network 100 is absent, the mobile is apparently in the network 150 (FIG. 1B) and step 906 is performed. In step 906, the mobile performs IPv6 within IPv4 tunneling. This is achieved by performing the sequence 800 (FIG. 8). Step 906 therefore offers the benefit of usability of many different networks since a foreign agent is not required.

Steps 908, 910 reevaluate network coverage on a period basis, whenever service is lost, or another schedule. If coverage changes, step 912 or 914 re-registers the mobile as appropriate to the new coverage (or lost coverage), after which the respective one of steps 904, 906 is performed. That is, step 904 is performed if step 906 was performed previously, or step 906 is performed if step 904 was performed previously.

### Other Embodiments

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

Moreover, the previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The word “exemplary” is used herein to mean “serving as an example, instance, or illustration.” Any embodiment described herein as “exemplary” is not necessarily to be construed as preferred or advantageous over other embodiments.

What is claimed is:

1. A method of assisting an exchange of data between one or mobile communications devices and the Internet in a mobile communications network, comprising operations of:
performing bidirectional tunneling of IPv6 messages inside IPv4 messages between a home agent and one or more foreign agents.

2. The method of claim 1, where at least one of the mobile communications devices comprise wireless mobile units, and the operations further comprise operating a wireless mobile unit to automatically engage in bidirectional tunneling of IPv6 messages inside IPv4 messages with the home agent whenever the wireless mobile unit detects loss of wireless coverage in the mobile communications network and presence of coverage in a type of wireless network lacking foreign agent functionality.

3. The method of claim 1, the operations further comprising:
assigning IPv6 addresses to each of the one or more mobile communications devices by performing operations comprising:
the mobile communications device sending a registration request to the home agent asking for an IPv6 format address;
the home agent responding to the registration request by sending an IPv6 format address to the mobile communications device.

4. The method of claim 1, the operations further comprising:
assigning IPv6 addresses to each of the one or more mobile communications devices by performing operations comprising:
the mobile communications device sending a registration request to the home agent asking for an IPv4 format address;
the home agent replying to the registration request by sending an IPv4 format address to the mobile communications device;
the mobile communications device sending a router solicitation to the home agent asking for an IPv6 format address;
the home agent responding to the router solicitation by sending an advertisement containing assignment of at least part of an IPv6 address.

5. The method of claim 1, the operations further comprising:
assigning IPv6 addresses to each of the one or more mobile communications devices by performing operations comprising:
the mobile communications device sending a registration request to the home agent asking for an IPv4 format address;
responsive to the registration request, the home agent sending an IPv4 format address to the mobile communications device;
also responsive to the registration request, the home agent determining whether the wireless telephone is IPv6 compatible, and if so, sending an advertisement containing at least part of an IPv6 prefix.

6. A mobile communications network conducting an exchange of data between one or mobile communications devices and the Internet, comprising:
a home agent;
multiple foreign agents;
where the home agent and each of one or more foreign agents perform bidirectional tunneling of IPv6 messages inside IPv4 messages.

7. A method of utilizing a mobile communications device to access the Internet in a communications network that includes multiple internet protocol (IP) foreign agents coupled to an IP home agent coupled to the Internet, the home agent comprising a default router for a subnet of which the mobile communications device is a member, where the home agent receives all packets from the Internet addressed to the mobile communications device and directs them to the mobile communications device, and where the home agent also receives all packets from the mobile communications device addressed to the Internet, the method comprising operations of:
assigning an IPv6 address to the mobile communications device;
processing outbound messages by performing operations comprising:
the mobile communications device sending outbound IPv6 messages to a selected one of the foreign agents;
the selected foreign agent encapsulating outbound IPv6 messages from the mobile communications device within IPv4 message shells and transmitting the encapsulated messages to the home agent;
the home agent unencapsulating the outbound IPv6 messages and transmitting the outbound IPv6 messages to the Internet;
processing inbound messages by performing operations comprising:
the home agent receiving IPv6 format inbound messages arriving from the Internet and addressed to the mobile communications device and encapsulating the received messages within IPv4 message shells;
the home agent forwarding the encapsulated received messages to a chosen foreign agent for transmission to the mobile communications device;
the chosen foreign agent unencapsulating the inbound messages from their shells and forwarding the unencapsulated inbound message to the mobile communications device.

8. The method of claim 1, the assigning operation comprising:
the mobile communications device sending a registration request to the home agent asking for an IPv6 format address;
the home agent responding to the registration request by sending an IPv6 format address.

9. The method of claim 1, the assigning operation comprising:
the mobile communications device sending a registration request to the home agent asking for an IPv4 format address;
the home agent replying to the registration request by sending an IPv4 format address to the mobile communications device;
the mobile communications device sending a router solicitation to the home agent asking for an IPv6 format address;
the home agent responding to the router solicitation by sending an advertisement containing assignment of at least part of an IPv6 address.

10. The method of claim 1, the assigning operation comprising:
the mobile communications device sending a registration request to the home agent asking for an IPv4 format address;
responsive to the registration request, the home agent sending an IPv4 format address to the mobile communications device;
also responsive to the registration request, the home agent determining whether the wireless telephone is IPv6 compatible, and if so, sending an advertisement containing at least part of an IPv6 prefix.

11. A wireless communications system, comprising:
multiple internet protocol (IP) foreign agents;
an IP home agent coupled the foreign agents and also coupled to the Internet, the home agent comprising a default router for a subnet of which a designated mobile communications device is a member, where the home agent receives all packets from the Internet addressed to the mobile communications device and directs them to the mobile communications device, and where the home agent also receives all packets from the mobile communications device addressed for the Internet;
where the foreign agents and home agent are programmed to process outbound messages by performing operations comprising:
responsive to receiving outbound IPv6 messages from the mobile communications device, a foreign agent encapsulating the outbound IPv6 messages within IPv4 message shells and transmitting the encapsulated messages to the home agent;
the home agent unencapsulating the outbound IPv6 messages and transmitting the outbound IPv6 messages to the Internet;
where the foreign agents and home agent are programmed to process inbound messages by performing operations comprising:
the home agent receiving IPv6 format inbound messages arriving from the Internet and directed at the mobile communications device and encapsulating the received messages within IPv4 message shells;
the home agent forwarding the encapsulated received messages to a chosen foreign agent for transmission to the mobile communications device;
the chosen foreign agent unencapsulating the inbound messages from their shells and forwarding the unencapsulated inbound message to the mobile communications device.

12. A method of utilizing a mobile communications device to access the Internet in a communications network that includes an IP home agent that is coupled to the Internet, the home agent comprising a default router for a subnet of which the mobile communications device is a member, where the home agent receives all packets from the Internet addressed to the mobile communications device and directs them to the mobile communications device, and where the home agent also receives all packets from the mobile communications device addressed to the Internet, the method comprising operations of:
assigning an IPv6 address to the mobile communications device;
responsive to the mobile communications device receiving communications linkage to the home agent via an internet protocol (IP) link that includes multiple foreign agents coupled to the home agent, performing operations comprising:
processing outbound messages by performing operations comprising:
the mobile communications device sending outbound IPv6 messages to a selected one of the foreign agents;
the selected foreign agent encapsulating outbound IPv6 messages from the mobile communications device within IPv4 message shells and transmitting the encapsulated messages to the home agent;
the home agent unencapsulating the outbound IPv6 messages and transmitting the outbound IPv6 messages to the Internet;
processing inbound messages by performing operations comprising:
the home agent receiving IPv6 format inbound messages arriving from the Internet and directed at the mobile communications device and encapsulating the received messages within IPv4 message shells;
the home agent forwarding the encapsulated received messages to chosen foreign agent for transmission to the mobile communications device;
the chosen foreign agent unencapsulating the inbound messages from their shells and forwarding the unencapsulated inbound message to the mobile communications device;
responsive to the mobile communications device receiving communications linkage to the home agent via a non-Internet IP link, performing operations comprising:
processing outbound messages by performing operations comprising:
the mobile communications device encapsulating outbound IPv6 messages within IPv4 message shells and transmitting the encapsulated messages to the home agent via the non-Internet IP link;
the home agent unencapsulating the outbound IPv6 messages and transmitting the outbound IPv6 messages to the Internet;
processing inbound messages by performing operations comprising:
the home agent receiving IPv6 format inbound messages arriving from the Internet and directed at the mobile communications device and encapsulating the received messages within IPv4 message shells;
the home agent forwarding the encapsulated received messages to the mobile communications device via the non-Internet IP ink;
the mobile communications device unencapsulating the inbound messages from their shells.

13. A method of operating a mobile communications device to access the Internet in a communications network that includes various links to an IP home agent that is coupled to the Internet, the operations comprising:
the mobile communications device detecting whether or not the mobile communications device is receiving service from a first type of link that includes multiple foreign agents coupled to the home agent, or whether the mobile communications device is receiving service from a second type of link comprising a non-Internet IP link;
responsive to a detection of the first type of link, the mobile communications device sending outbound IPv6 messages to a selected one of the foreign agents;
responsive to a detection of the second type of link, the mobile communications device encapsulating outbound IPv6 messages within IPv4 message shells and transmitting the encapsulated messages to the home agent via the non-Internet IP link.

14. Circuitry including multiple interconnected electrically conductive elements configured to perform operations to operate a mobile communications device (mobile communications device) in a communications network that includes various mid-links coupled to an IP home agent that is coupled to the Internet, the operations comprising:
the mobile communications device detecting whether or not the mobile communications device is receiving service from a first type of link that includes multiple foreign agents coupled to the home agent, or whether the mobile communications device is receiving service from a second type of link comprising a non-Internet IP link;
responsive to a detection of the first type of link, the mobile communications device sending outbound IPv6 messages to a selected one of the foreign agents;
responsive to a detection of the second type of link, the mobile communications device encapsulating outbound IPv6 messages within IPv4 message shells and transmitting the encapsulated messages to the home agent via the non-Internet IP link.
